(19) United States
(12) Patent Application Publication
(10) Pub. No.: US 2005/0102611 A1
(43) Pub. Date: May 12, 2005

(54) Process for creating dynamic web pages driven from the server side

(76) Inventor: Danny Chen, New York, NY (US)

Correspondence Address: BOND, SCHOENECK & KING, PLLC, ONE LINCOLN CENTER, SYRACUSE, NY, 13202-1355, US

(21) Appl. No.: 10/702,632

(22) Filed: Nov. 6, 2003

(51) Int. Cl. G06F 17/24

(52) U.S. Cl. 715/513

(57) ABSTRACT

A process for creating server-driven dynamic web content without the use of browser add-ins or plug-in programs. Rather than relying on a plug-in on the browser side, the server uses an independent and persistent HTTP connection to stream commands to the browser that result in dynamic updates of the displayed web page. When a browser requests a page that will be dynamically updated from the server side, the server makes an HTTP reply that results in the browser making at least two HTTP requests. The first request results in the server providing a display page. The second request establishes an independent HTTP connection that serves as a control stream for the server to send commands to the browser. The commands are implemented through the document object model of the browser and result in the dynamic updating of the display page.

### BACKGROUND OF THE INVENTION

1. Field of Invention

The present invention relates to internet web pages and, more specifically, to a process for creating server-side controllable dynamic web pages in modern web browsers (HTTP clients).

2. Description of Prior Art

Internet web pages were initially intended to be static and the web page delivery protocol, HTTP, was designed for the request and delivery of static web pages. Dynamic content has since been added to web pages to enable animation and create “live” pages. Convention says that dynamic web pages with updates driven by the server side, as opposed to the user, require external programs, such as Java or ActiveX components, to enable the animation or dynamic content. Plug-ins generally receive individual executable programs from the server, such as applets, and then run the programs to provide server driven dynamic content.

Although these external programs can provide the desired server driven dynamic content, such programs are nevertheless disadvantageous because they require downloading and/or installation before server driven dynamic content is available. The use of external programs also involves encumbrances such as version upgrades, which leads to code maintenance, and security compliance must be performed on each external program.

3. Objects and Advantages

It is a principal object and advantage of the present invention to provide a method for creating dynamic web pages driven by the server using native modern web browser capabilities, such as a comprehensive and global document object model and scripting language that is able to access the document object model.

It is an additional object and advantage of the present invention to provide a method for creating server driven dynamic web pages that does not require downloading and/or installing additional programs into a modem web browser.

It is a further object and advantage of the present invention to provide a method for creating dynamic web pages that does not require additional security compliance certification.

Other objects and advantages of the present invention will in part be obvious, and in part appear hereinafter.

### SUMMARY OF THE INVENTION

The present invention comprises a process for creating server-side controllable dynamic web content in web browsers (HTTP clients) that support a document object model and a scripting language able to access the document object model, without the use of browser add-in or plug-in programs, such as Java or ActiveX components. The process comprises the use of two or more independent HTTP request streams: one for displaying a webpage and another for streaming the commands that create dynamic updates. At least a first stream loads into the HTTP client for the creation of visible content, the “display stream.” At least a second stream forms an invisible “control stream” that sends native browser scripts to effect the desired change in visible content. The control stream may also establish an HTTP “heartbeat” to avoid client timeouts, per HTTP specifications, and can optionally control an inadvertent termination of the control stream.

### BRIEF DESCRIPTION OF THE DRAWINGS

FIG. 1 is a high-level flow chart of a process for creating dynamic web content according to the present invention.

FIG. 2 is a mid-level flowchart of the dynamic updating of a display page according to the present invention.

### DETAILED DESCRIPTION

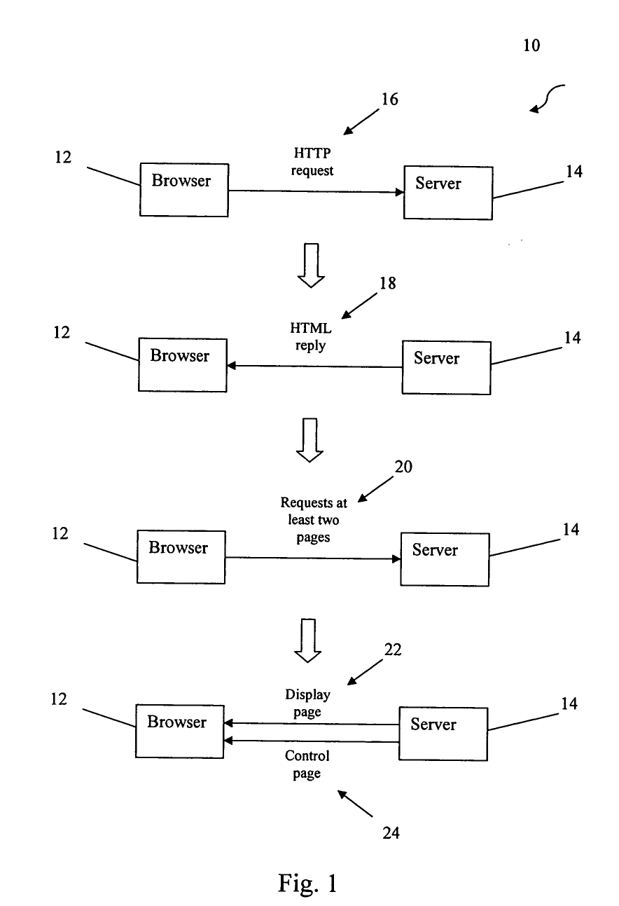

Referring now to the figures wherein like numerals refer to like parts throughout, there is seen in FIG. 1 a process 10 for enabling dynamic web content in a modem web browser 12 (i.e., one that supports HTML 4.0 and higher and implements standard DHTML constructs and a document object model in a global namespace) from the server 14 side. Process 10 begins when browser 12 makes a standard HTTP request 16 of server 14 for a web page that server 14 will provide dynamic content. In response to the HTTP request 16, server 14 make an HTML reply 18. HTML reply 18 results in browser making at least two HTTP requests 20. A standard HTML reply, such as one that would otherwise trigger browser 12 to request multiple frames, DHTML, floating frames, or the creation of sub-windows, is used to trigger browser 12 to make multiple HTTP requests 20. For example, the following HTML code will create two independent streams using frames:

<frameset rows=”10,10”>
<frame id=display src=display1.html>
<frame id=control src=display2.html>
</frameset>

In response to multiple HTTP requests 20 from browser 12, server 16 provides at least one display page 22 and at least one control page 24. Display page 22 is the original web page sought by browser 12 that is enhanced according to process 10 to include dynamic content. Control page 24 serves as a control HTTP stream through which commands 26 are sent to browser 12 to create the dynamic content. Control page 24 is preferably made invisible to the user of browser 12 through the use of conventional HTML techniques, such as invisible pop-up windows. Control page 24 may also comprise a hidden frame or floating frame as long as the HTTP stream is established independent from the HTTP stream of display page 22. In order to insure that control page 24 does not time-out in clients implementing the HTTP timeout protocol (inter-character), server 14 should periodically sends non-operational messages (i.e. messages with no side-effects) through the HTTP stream of control page 24.

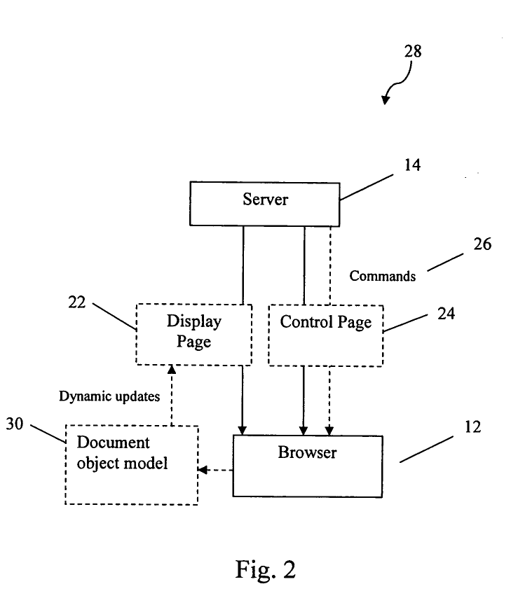

Referring to FIG. 2, the dynamic updating 28 of display page 22 occurs when server 14 sends commands 26 through control page 24 to browser 12. Commands 26 comprise the DHTML instructions for changing predetermined portions of display page 22, thereby creating dynamic content. Commands 26 are complete script fragments that are packaged into a segment of a multi-part HTTP reply. As the script fragments are delivered into browser 12, they are interpreted and executed by the script handling capabilities of browser accessing the document object model, thereby resulting in the desired dynamic changes in the display page 22. As a result, server 14 can perform dynamic updates to display page 22, thereby allowing for dynamic content such as stock price ticks, temperature fluctuations, etc. that is ordinarily only achieved by using browser plug-ins.

The two independent streams, one for display page 22 and one for control page 24, are used to avoid the problem of browsers 12 being of indeterminate behavior when it comes to script operations on pages that have not fully loaded. By loading display page 22 separately, the problem is avoided. By using an event handler, such as onLoad, to initiate the loading of control page 24, the possibility of control stream 24 operating on objects on display page 22 that have yet to be loaded is eliminated. Since the HTTP stream of control page 24 never closes, the event handler of control page 24 can catch an inadvertent disconnection establish a reconnection using any reasonable conventional reconnection strategy.

1. A process of creating dynamic content in a webpage, comprising:
establishing a first HTTP stream between a server and a browser, said browser having a document object model and a scripting language capable of accessing the document object model, wherein said browser is capable of event handling;
transmitting said webpage to said browser through said first HTTP stream; and
establishing a second HTTP stream between said server and said browser;
sending commands in said scripting language from said server to said browser through said second HTTP stream, wherein said commands are implemented through said document object model to dynamically alter said webpage.

2. The process of claim 1, further comprising sending non-operational messages through said second HTTP stream to prevent termination of said second HTTP stream by said browser.

3. The process of claim 1, wherein said second HTTP stream is invisible to a user of said browser.

4. The process of claim 1, wherein said first HTTP stream is established and said webpage is transmitted before said second HTTP stream is established.

5. The process of claim 2, wherein said non-operational messages are null scripts.

6. A system for enabling dynamic content in a webpage, comprising:
a server for establishing at least two independent HTTP connections;
a browser having a document object model and a scripting language capable of accessing the document object model, wherein said browser is capable of event handling; and
wherein said server provides a webpage through at least a first of said two independent HTTP connections and sends commands in said scripting language through at least a second of said two independent HTTP connections and wherein said commands are implemented by said browser through said document object model to update said webpage.

7. The system of claim 6, wherein said webpage is provided to said browser before said commands are sent to said browser.

8. The system of claim 6, wherein said first of said two independent HTTP connections is established before said second of said two independent HTTP connections.

9. The system of claim 65, wherein said commands are complete script fragments packaged into a segment of a multi-part HTTP reply.
